(19) United States
(12) Patent Application Publication
(10) Pub. No.: US 2022/0223349 A1
(43) Pub. Date: Jul. 14, 2022

(54) ELECTROLYTIC CAPACITOR, AND METHOD FOR MANUFACTURING ELECTROLYTIC CAPACITOR

(71) Applicant: Murata Manufacturing Co., Ltd., Nagaokakyo-shi (JP)

(72) Inventors: Yasuhiro TAMATANI, Nagaokakyo-shi (JP); Kazuya KUSUDA, Nagaokakyo-shi (JP)

(21) Appl. No.: 17/657,711

(22) Filed: Apr. 1, 2022

Related U.S. Application Data
(63) Continuation of application No. PCT/JP2020/037411, filed on Oct. 1, 2020.

(30) Foreign Application Priority Data
Oct. 4, 2019 (JP) 2019-183947

(51) Int. Cl. H01G 9/042; H01G 9/012; H01G 4/30; H01G 9/00

(52) U.S. Cl. CPC H01G 9/042; H01G 9/0029; H01G 4/30; H01G 9/012

(57) ABSTRACT

An electrolytic capacitor that includes: a cuboid resin molded body having a first end surface and a second end surface opposite to each other, the cuboid resin molded body including a stack that includes a capacitor element with an anode having a dielectric layer on a surface thereof and a cathode opposite to the anode, and a sealing resin that seals the stack, the anode being exposed on the first end surface and the cathode being exposed at the second end surface; a first external electrode on the first end surface of the resin molded body; and a second external electrode on the second end surface of the resin molded body, wherein the first and second external electrodes include: an Ag or Cu plating layer; and a resin electrode layer on a surface of the Ag or Cu plating layer and containing a conductive component and a resin component.

### CROSS REFERENCE TO RELATED APPLICATIONS

The present application is a continuation of International application No. PCT/JP2020/037411, filed Oct. 1, 2020, which claims priority to Japanese Patent Application No. 2019-183947, filed Oct. 4, 2019, the entire contents of each of which are incorporated herein by reference.

### FIELD OF THE INVENTION

The present invention relates to electrolytic capacitors and methods for manufacturing electrolytic capacitors.

### BACKGROUND OF THE INVENTION

Patent Literature 1 discloses a multilayer ceramic capacitor.

This multilayer ceramic capacitor is produced by dipping a first surface and a second surface of a capacitor body in an electrode paste, drying and baking the electrode paste to form a first base film for an external electrode, printing the electrode paste on both end portions of a fifth surface of the capacitor body in the length direction, drying and baking the electrode paste to form a second base film for an external electrode to be continuous with the first base film.

Patent Literature 2 discloses a method of forming an external electrode on a ceramic capacitor. Specifically, the method includes a first paste layer forming step of performing screen printing on an end surface of a body and a second paste layer forming step of performing screen printing on a main surface of the body, wherein the first paste layer forming step is followed by a first baking step, and the second paste layer forming step is followed by a second baking step.
Patent Literature 1: JP 2017-152620 A
Patent Literature 2: JP 2012-4480 A

### SUMMARY OF THE INVENTION

According to the techniques disclosed in Patent Literatures 1 and 2, an electrode paste is screen printed on a ceramic body, and subsequently, baking is performed at a high temperature of 600° C. to 800° C. The electrode paste composition, electrode paste rheology, electrode paste printing conditions, and the like are suitable for the baking.

An electrolytic capacitor such as a solid electrolytic capacitor may have a configuration in which a stack including a capacitor element with an anode having a dielectric layer on a surface thereof and a cathode opposite to the anode is sealed in a resin molded body, and external electrode are formed on the resin molded body.

When forming the external electrode on the resin molded body, an electrode layer cannot be formed by baking or the like at a high temperature, so that it is difficult to improve adhesion between the resin molded body and the electrode layer. Thus, the external electrode formation methods disclosed in Patent Literatures 1 and 2 cannot be used directly.

Thus, suggested is formation of external electrodes on a surface of a resin molded body by a method including forming an inner plating layer in direct contact with a cathode or an anode, an outer plating layer in direct contact with a solder, and a resin electrode layer for preventing cracking of the external electrode. The resin electrode layer is placed between the inner plating layer and the outer plating layer.

The inner plating layer is required to have high adhesion to the anode or the cathode. A Ni plating has excellent adhesion to the anode and the cathode, but is easily oxidized. In response to the problem, suggested is formation of the inner plating layer having a two-layer structure of a Ni plating layer and a plating layer for preventing the oxidation of the Ni plating (e.g., an Ag plating layer).

The outer plating layer is required to have high solder wettability. However, when a Sn plating layer having high solder wettability is directly formed on a surface of the resin electrode layer, the Sn plating layer has poor adhesion to the resin electrode layer. Thus, the outer plating layer is required to be formed by forming first a Ni plating layer on the surface of the resin electrode layer, followed by forming a Sn plating layer on the surface of the Ni plating layer.

This provides an external electrode having a five-layer structure including two inner plating layers (Ni/Ag), a resin electrode layer, and two outer plating layers (Ni/Sn).

The external electrode having such a structure may increase the production cost due to its too many electrode layers.

In addition, due to many interfaces between the electrode layers, the interface resistance may increase the ESR.

The present invention aims to provide an electrolytic capacitor and a method for manufacturing the electrolytic capacitor each capable of preventing an increase in the production cost and an increase in the ESR.

The present invention provides an electrolytic capacitor including: a cuboid resin molded body having a first end surface and a second end surface opposite to each other, the cuboid resin molded body including a stack that includes a capacitor element with an anode having a dielectric layer on a surface thereof and a cathode opposite to the anode, and a sealing resin that seals the stack, the anode being exposed on the first end surface and the cathode being exposed at the second end surface; a first external electrode on the first end surface of the resin molded body and electrically connected to the anode exposed on the first end surface, the first external electrode including: an Ag plating layer or a Cu plating layer on a surface of the anode exposed on the first end surface of the resin molded body; and a resin electrode layer on a surface of the Ag plating layer or on a surface of the Cu plating layer and containing a conductive component and a resin component; and a second external electrode on the second end surface of the resin molded body and electrically connected to the cathode exposed on the second end surface, the second external electrode including: an Ag plating layer or a Cu plating layer on a surface of the cathode exposed on the second end surface of the resin molded body; and a resin electrode layer on a surface of the Ag plating layer or on a surface of the Cu plating layer and containing a conductive component and a resin component.

The present invention also provides a method for manufacturing an electrolytic capacitor, the method including: preparing a stack that includes a capacitor element with an anode having a dielectric layer on a surface thereof and a cathode opposite to the anode; sealing the stack with a sealing resin to obtain a cuboid resin molded body; forming a first external electrode on a first end surface of the resin molded body such that the first external electrode is electrically connected to the anode exposed on the first end surface, wherein the forming of the first external electrode includes electroless Ag plating or electroless Cu plating and forming a resin electrode layer on the first end surface of the resin molded body; and forming a second external electrode on a second end surface of the resin molded body such that the second external electrode is electrically connected to the cathode exposed on the second end surface, wherein the forming of the second external electrode includes electroless Ag plating or electroless Cu plating and forming a resin electrode layer on the second end surface of the resin molded body.

The present invention provides an electrolytic capacitor and a method for manufacturing the electrolytic capacitor each capable of preventing an increase in the production cost and an increase in the ESR.

### BRIEF DESCRIPTION OF THE DRAWINGS

FIG. 1 is a schematic perspective view of an example of an electrolytic capacitor of the present invention.

FIG. 2 is a cross-sectional view taken along line A-A of the electrolytic capacitor shown in FIG. 1.

FIG. 3 is a graph showing the relation between the film thickness of the electroless Ag plating layer and the ESR in each of Examples 1 to 5.

FIG. 4 is a graph showing the relation between the film thickness of the electroless Cu plating layer and the ESR in each of Examples 6 to 10.

FIG. 5 is a graph showing the relation between the film thickness of the electroless Ni plating layer and the ESR in each of Comparative Examples 1 to 3.

### DETAILED DESCRIPTION OF THE PREFERRED EMBODIMENTS

An electrolytic capacitor and a method for manufacturing the electrolytic capacitor of the present invention are described below.

The present invention is not limited to the following preferred embodiments, and may be suitably modified without departing from the gist of the present invention. Combinations of two or more preferred features described in the following preferred embodiments are also within the scope of the present invention.

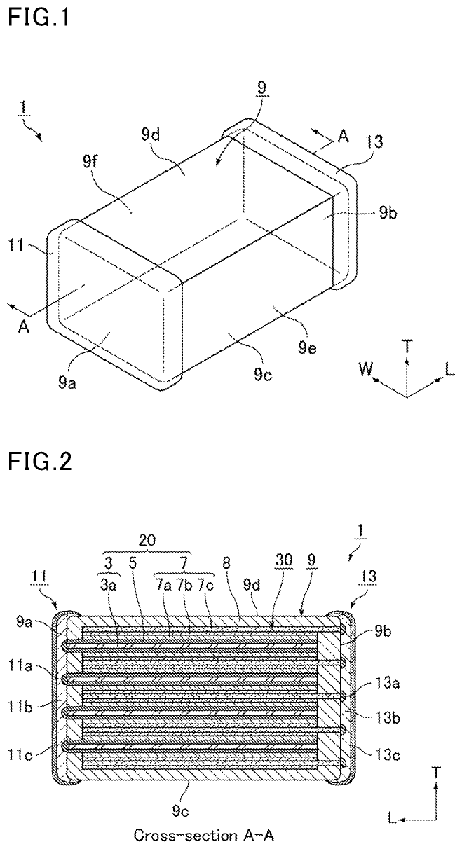

FIG. 1 is a schematic perspective view of an example of the electrolytic capacitor of the present invention.

FIG. 1 shows a cuboid resin molded body 9 of an electrolytic capacitor 1.

The resin molded body 9 has a length direction (L direction), a width direction (W direction), and a thickness direction (T direction), and includes a first end surface 9a and a second end surface 9b which are opposite to each other in the length direction. A first external electrode 11 is formed on the first end surface 9a, and a second external electrode 13 is formed on the second end surface 9b.

The resin molded body 9 includes a bottom surface 9c and a top surface 9d which are opposite to each other in the thickness direction.

The resin molded body 9 also includes a first side surface 9e and a second side surface 9f which are opposite to each other in the width direction.

Herein, a plane along the length direction (L direction) and the thickness direction (T direction) of the electrolytic capacitor or the resin molded body is referred to as an “LT plane”, a plane along the length direction (L direction) and the width direction (W direction) is referred to as an “LW plane”, and a plane along the thickness direction (T direction) and the width direction (W direction) is referred to as a “WT plane”.

FIG. 2 is a cross-sectional view taken along line A-A of the electrolytic capacitor shown in FIG. 1.

A capacitor element 20 includes an anode 3 having a dielectric layer 5 on a surface thereof and a cathode 7 opposite to the anode 3.

Multiple such capacitor elements 20 are stacked to form a stack 30, and the stack 30 is sealed in a sealing resin 8 to obtain the resin molded body 9. In the stack 30, the stacked capacitor elements 20 may be bonded to each other via a conductive adhesive (not shown).

The first external electrode 11 is formed on the first end surface 9a of the resin molded body 9, and the first external electrode 11 is electrically connected to the anode 3 exposed on the first end surface 9a.

The second external electrode 13 is formed on the second end surface 9b of the resin molded body 9, and the second external electrode 13 is electrically connected to the cathode 7 exposed on the second end surface 9b.

A second end surface 9b-side end of a valve-action metal foil 3a of the capacitor element 20 is sealed with the sealing resin 8, and the valve-action metal foil 3a is not in direct contact with a solid electrolyte layer 7a or a conductive layer 7b. When the second end surface 9b-side end of the valve-action metal foil 3a is insulated, for example, by being covered with the dielectric layer 5, the second end surface 9b-side end of the valve-action metal foil 3a may be covered with the solid electrolyte layer 7a and the conductive layer 7b.

The anode 3 defining the capacitor element 20 includes the valve-action metal foil 3a at a center thereof and a porous layer such as an etched layer (not shown) on a surface thereof. The dielectric layer 5 is provided on a surface of the porous layer.

Examples of the valve-action metal include elemental metals such as aluminum, tantalum, niobium, titanium, zirconium, magnesium, and silicon, and alloys containing these metals. Of these, aluminum and an aluminum alloy are preferred.

The valve-action metal may have any shape, but it is preferably flat, and is more preferably in the form of foil. Preferably, the porous layer is an etched layer that has been etched with hydrochloric acid or the like.

The thickness of the valve-action metal foil before etching is preferably 60 μm to 180 μm. The thickness of the non-etched valve-action metal foil (core) after etching is preferably 10 μm to 70 μm. The thickness of the porous layer is designed according to the withstand voltage and capacitance required for the electrolytic capacitor, but the thickness of the porous layer including the porous layers on both sides of the valve-action metal foil is preferably 10 μm to 120 μm.

The anode 3 is led out to the first end surface 9a of the resin molded body 9 and electrically connected to the first external electrode 11.

Preferably, the dielectric layer is formed of an oxide film of the valve-action metal. For example, when aluminum foil is used as a valve-action metal substrate, the aluminum foil is anodized in an aqueous solution containing boric acid, phosphoric acid, adipic acid, a sodium salt or an ammonium salt thereof, or the like, whereby an oxide film that serves as a dielectric layer can be formed.

The dielectric layer is formed along the surface of the porous layer, whereby pores (recesses) are formed in the dielectric layer. The thickness of the dielectric layer is designed according to the withstand voltage and capacitance required for the electrolytic capacitor, but the thickness of the dielectric layer is preferably 10 nm to 100 nm.

The cathode 7 of the capacitor element 20 is a stack including the solid electrolyte layer 7a on the dielectric layer 5, the conductive layer 7b on the solid electrolyte layer 7a, and a cathode lead-out layer 7c on the conductive layer 7b.

The electrolytic capacitor including a solid electrolyte layer as part of the cathode can be considered to be a solid electrolytic capacitor.

Examples of materials defining the solid electrolyte layer include conductive polymers having a skeleton of pyrrole, thiophene, aniline, or the like. A conductive polymer having a thiophene skeleton is, for example, poly(3,4-ethylenedioxythiophene) (PEDOT), or may be PEDOT:PSS which is a complex with a dopant (poly(styrene sulfonate) (PSS)).

The solid electrolyte layer is formed by, for example, a method in which a polymerized film of poly(3,4-ethylenedioxythiophene) or the like is formed on a surface of the dielectric layer using a treatment liquid containing a monomer such as 3,4-ethylenedioxythiophene or a method in which a dispersion of a polymer such as poly(3,4-ethylenedioxythiophene) is applied to a surface of the dielectric layer and dried. Preferably, a solid electrolyte layer for an inner layer for filling the pores (recesses) is formed first, and then a solid electrolyte layer for an outer layer for covering the entire dielectric layer is formed.

The solid electrolyte layer can be formed in a predetermined region by applying the treatment liquid or dispersion to the dielectric layer by, for example, sponge transfer, screen printing, spray coating, dispensing, or inkjet printing. The thickness of the solid electrolyte layer is preferably 2 μm to 20 μm.

The conductive layer is provided to electrically and mechanically connect the solid electrolyte layer to the cathode lead-out layer. For example, the conductive layer is preferably a carbon layer, a graphene layer, or a silver layer formed by applying a conductive paste such as a carbon paste, a graphene paste, or a silver paste. The conductive layer may be a composite layer in which a silver layer is provided on a carbon layer or a graphene layer, or a mixed layer containing a mixture of a carbon paste or a graphene paste with a silver paste.

The conductive layer can be formed on the solid electrolyte layer by applying a conductive paste such as a carbon paste by, for example, sponge transfer, screen printing, spray coating, dispensing, or inkjet printing. Preferably, a cathode lead-out layer formed in a subsequent step is stacked while the conductive layer is viscous before drying. The thickness of the conductive layer is preferably 2 μm to 20 μm.

The cathode lead-out layer can be formed from metal foil or a printed electrode layer.

In the case of the metal foil, the metal foil preferably contains at least one metal selected from the group consisting of Al, Cu, Ag, and an alloy mainly containing any of these metals. When the metal foil contains any of these metals, the metal foil can have a lower resistance value, and the ESR can be reduced.

Alternatively, the metal foil may be one whose surface is coated with carbon or titanium by a film forming method such as sputtering or vapor deposition. Use of carbon-coated Al foil is more preferred. The thickness of the metal foil is not limited, but it is preferably 20 μm to 50 μm, in view of better handling during production, smaller size, and lower ESR.

In the case of the printed electrode layer, the cathode lead-out layer can be formed in a predetermined region by applying an electrode paste to the conductive layer by, for example, sponge transfer, screen printing, spray coating, dispensing, or inkjet printing. The electrode paste is preferably one mainly containing Ag, Cu, or Ni. When the cathode lead-out layer is a printed electrode layer, the printed electrode layer can made thinner than the cathode lead-out layer formed from metal foil. In the case of screen printing, the printed electrode layer can have a thickness of 2 μm to 20 μm.

The cathode lead-out layer 7c is led out to the second end surface 9b of the resin molded body 9 and electrically connected to the second external electrode 13.

The sealing resin 8 defining the resin molded body 9 contains at least a resin, and preferably contains a resin and a filler. Preferably, examples of the resin include epoxy resins, phenolic resins, polyimide resins, silicone resins, polyamide resins, and liquid crystal polymers. The sealing resin 8 can be used in the form of either a solid resin or a liquid resin. Preferably, examples of the filler include silica particles, alumina particles, and metal particles. Use of a material obtained by adding silica particles to a solid epoxy resin and/or a phenolic resin is more preferred.

When a solid sealing material is used, preferably, the molding method of the resin molded body uses a resin mold such as a compression mold or a transfer mold. Use of a compression mold is more preferred. When a liquid sealing material is used, use of a molding method such as dispensing or printing is preferred. Preferably, a compression mold is used to seal the stack 30 of the capacitor elements 20 each including the anode 3, the dielectric layer 5, and the cathode 7 in the sealing resin 8 to obtain the resin molded body 9.

The resin molded body 9 has a cuboid shape, and includes the top surface 9d and the bottom surface 9c as the LW planes, the first side surface 9e and the second side surface 9f as the LT planes, and the first end surface 9a and the second end surface 9b as the WT planes.

In the resin molded body 9, corner portions are rounded to have an R (curvature radius) by barrel polishing after molding in a resin mold. A resin molded body is softer than a ceramic body and it is thus difficult to round each corner to have an R by barrel polishing. Yet, each corner can be rounded to have a small R by adjusting the composition, particle size, and shape of a medium, treatment time in a barrel, and the like.

The following specifically describes the configurations of the external electrodes included in the electrolytic capacitor of the present invention.

In the electrolytic capacitor of the present invention, the first external electrode includes: an Ag plating layer or a Cu plating layer formed on a surface of the anode exposed on the first end surface of the resin molded body; and a resin electrode layer formed on a surface of the Ag plating layer or on a surface of the Cu plating layer and containing a conductive component and a resin component, and the second external electrode includes: an Ag plating layer or a Cu plating layer formed on a surface of the cathode exposed on the second end surface of the resin molded body; and a resin electrode layer formed on a surface of the Ag plating layer or on a surface of the Cu plating layer and containing a conductive component and a resin component.

The external electrodes may each further include an outer plating layer formed outside of each of the resin electrode layers.

In the case where the inner plating layer of each of the external electrodes is an Ag plating layer or a Cu plating layer, the inner plating layer is a single layer, in which the number of interfaces is smaller than that in the case where two layers of a Ni plating layer and an Ag plating layer are provided as inner plating layers. Thus, the interface resistance is reduced to achieve low ESR.

Also, in the case where the inner plating layer is an Ag plating layer or a Cu plating layer, the ESR can be lower than that in the case where the inner plating layer is a Ni plating layer (single layer).

The following describes the first external electrode and the second external electrode each including an Ag plating or a Cu plating layer, a resin electrode layer, and an outer plating layer with reference to FIG. 2.

The resin electrode layer shown in FIG. 2 is a printed resin electrode layer formed by screen printing an electrode paste.

FIG. 2 shows layer structures of the first external electrode 11 and the second external electrode 13 included in the electrolytic capacitor 1.

The first external electrode 11 includes an Ag plating or Cu plating layer 11a, a resin electrode layer 11b, and an outer plating layer 11c.

The second external electrode 13 includes an Ag plating or Cu plating layer 13a, a resin electrode layer 13b, and an outer plating layer 13c.

Preferably, the Ag plating or Cu plating layer 11a is formed through a zincate treatment.

The zincate treatment is a treatment in which an oxide is removed from a surface of a metal to be plated and a zinc (Zn) film is formed on the surface.

Specifically, the surface of aluminum foil of the anode 3 exposed on the first end surface of the resin molded body 9 is etched with an acid containing nitric acid as a main component to remove an oxide film of the anode 3, and Zn plating is then performed. In the zincate treatment, both of single zincate (pickling) and double zincate (peeling) are preferably performed.

Subsequently, displacement plating is performed by electroless Ag plating or electroless Cu plating, whereby the Ag plating or Cu plating layer 11a is formed.

The Ag plating or Cu plating layer 13a on the surface of the cathode lead-out layer 7c can be formed in the same manner as for the Ag plating or Cu plating layer 11a formed on the surface of the anode 3. In this case, the zincate treatment may not be performed. When the cathode lead-out layer 7c contains Al, the zincate treatment is preferably performed.

Specifically, preferably, a zincate treatment of at least one of the first end surface of the resin molded body or the second end surface of the resin molded body is performed prior to the electroless Ag plating or the electroless Cu plating.

When the first external electrode and the second external electrode each include an Ag plating layer, the Ag plating layer preferably has a thickness of 0.1 μm to 2.0 μm, more preferably 0.2 μm to 1.0 μm.

Even the Ag plating layer having a relatively small thickness within the above range can achieve an ESR reduction effect.

When the first external electrode and the second external electrode each include a Cu plating layer, the Cu plating layer preferably has a thickness of 0.2 μm to 4.0 μm, more preferably 0.5 μm to 2.0 μm.

The Cu plating layer having a thickness within the above range secures a thickness required as a plating layer and achieves sufficiently low ESR.

The thickness of the Ag plating layer or the Cu plating layer is determined by measuring the length of a line drawn in a direction perpendicular to the first end surface or the second end surface in a cross-sectional micrograph taken in a cross-section (LT plane) as shown in FIG. 2. The thickness of each of the Ag plating layers or the Cu plating layers formed corresponding to the anodes and the cathode lead-out layers is determined by measuring the thicknesses of five or more portions of each of the Ag plating layer and Cu plating layer, and averaging the thicknesses.

The resin electrode layers 11b and 13b each contain a conductive component and a resin component.

Preferably, the conductive component mainly includes a component such as Ag, Cu, Ni, or Sn, and the resin component mainly includes an epoxy resin, a phenolic resin, or the like.

In particular, the resin electrode layer is preferably a resin electrode layer containing Ag. The resin electrode layer containing Ag can reduce ESR owing to the low specific resistance of Ag.

Preferably, each resin electrode layer contains a conductive component in an amount of 67 wt % to 97 wt % and a resin component in an amount of 3 wt % to 33 wt %.

More preferably, the resin electrode layer contains a conductive component in an amount of 72 wt % to 95 wt % and a resin component in an amount of 5 wt % to 28 wt %.

Still more preferably, the resin electrode layer contains a conductive component in an amount of 78 wt % to 95 wt % and a resin component in an amount of 5 wt % to 22 wt %.

Particularly preferably, the resin electrode layer contains a conductive component in an amount of 79 wt % to 89 wt % and a resin component in an amount of 11 wt % to 21 wt %.

Preferably, each resin electrode layer is a printed resin electrode layer formed by screen printing an electrode paste. More preferably, the electrode paste is an Ag electrode paste containing a resin and an Ag filler containing Ag as a conductive component, and each resin electrode layer is an Ag printed resin electrode layer formed by screen printing.

When the resin electrode layer is a printed resin electrode layer, the external electrodes can be made flat, as compared to the case where the resin electrode is formed by dipping in an electrode paste. In other words, the first external electrode and the second external electrode have better thickness uniformity.

When the flatness of each of the first external electrode and the second external electrode is measured in a cross section as shown in FIG. 2, preferably, the variation in thickness of the first external electrode measured from the first end surface of the resin molded body and the variation in thickness of the second external electrode measured from the second end surface of the resin molded body are each 30 μm or less. More preferably, these variations in thickness are each 20 μm or less. Still more preferably, these variations in thickness are each 5 μm or less.

The variation in thickness of the first external electrode or the second external electrode can be determined from the difference between the maximum value and the minimum value of the thicknesses measured at five points: three points that divide the stack from a top surface to a bottom surface into four equal parts, the top surface, and the bottom surface, in the cross-sectional view shown in FIG. 2. Alternatively, the thicknesses at multiple points may be non-destructively measured using a fluorescent X-ray film thickness meter, a laser displacement meter, or the like.

When the resin electrode layers are printed resin electrode layers formed by screen printing an electrode paste, the electrode paste preferably contains a conductive component in an amount of 60 wt % to 95 wt % and a resin component in an amount of 3 wt % to 30 wt %.

More preferably, the electrode paste contains a conductive component in an amount of 65 wt % to 90 wt % and a resin component in an amount of 5 wt % to 25 wt %.

Still more preferably, the electrode paste contains a conductive component in an amount of 70 wt % to 90 wt % and a resin component in an amount of 5 wt % to 20 wt %.

Yet still more preferably, the electrode paste contains a conductive component in an amount of 75 wt % to 85 wt % and a resin component in an amount of 10 wt % to 20 wt %.

The electrode paste may contain an organic solvent, and the organic solvent is preferably a glycol ether-based solvent. Examples include diethylene glycol monobutyl ether and diethylene glycol monophenyl ether.

The electrode paste may also contain an additive, if necessary. The additive is effective in adjusting the rheology, especially thixotropy, of the electrode paste. The amount of the additive contained is preferably less than 5 wt % relative to the weight of the electrode paste.

An outer plating layer may be formed on the surface of resin electrode layer.

Preferably, the outer plating layers are each a Ni plating layer or a Sn plating layer.

When the outer plating layers each include two layers, each outer plating layer may include a first outer plating layer formed on the surface of the resin electrode layer and a second outer plating layer formed on the surface of the first outer plating layer.

Preferably, the first outer plating layer is a Ni plating layer and the second outer plating layer is a Sn plating layer.

Examples of preferred ranges of the dimensions of the electrolytic capacitor of the present invention are as described below.

Dimensions of Electrolytic Capacitor

Dimension of L: 3.4 mm to 3.8 mm; representative value: 3.5 mm

Dimension of W: 2.7 mm to 3.0 mm; representative value: 2.8 mm

Dimension of T: 1.8 mm to 2.0 mm; representative value: 1.9 mm

The following describes a method for manufacturing an electrolytic capacitor of the present invention.

The electrolytic capacitor of the present invention can be produced by the method for manufacturing an electrolytic capacitor of the present invention.

The method for manufacturing an electrolytic capacitor of the present invention includes: preparing a stack that includes a capacitor element with an anode having a dielectric layer on a surface thereof and a cathode opposite to the anode; sealing the stack with a sealing resin to obtain a cuboid resin molded body; forming a first external electrode on a first end surface of the resin molded body, the first external electrode being electrically connected to the anode exposed on the first end surface; and forming a second external electrode on a second end surface of the resin molded body, the second external electrode being electrically connected to the cathode exposed on the second end surface, wherein the forming the first external electrode includes electroless Ag plating or electroless Cu plating and forming a resin electrode layer on the first end surface of the resin molded body, and wherein the forming the second external electrode includes electroless Ag plating or electroless Cu plating and forming a resin electrode layer on the second end surface of the resin molded body.

Production of Capacitor Element

A valve-action metal foil, such as aluminum foil, having a porous layer such as an etched layer on a surface thereof is prepared, and a surface of the porous layer is anodized to form a dielectric layer.

A solid electrolyte layer is formed on the dielectric layer by screen printing. Subsequently, a carbon layer is formed on the solid electrolyte layer by screen printing, and further, a cathode lead-out layer is formed on the carbon layer by sheet stacking or screen printing.

A capacitor element is obtained by the above steps.

Stacking of Capacitor Elements and Sealing with Resin

Multiple capacitor elements are stacked into a stack, and the stack is sealed in a sealing resin by a compression mold to produce a cuboid resin molded body.

Formation of External Electrodes

On a first end surface of a resin molded body is formed a first external electrode electrically connected to an anode exposed on the first end surface. The anode exposed on the first end surface is subjected to electroless Ag plating or electroless Cu plating.

In particular, preferably, the anode exposed on the first end surface is subjected to a zincate treatment, followed by electroless Ag plating or electroless Cu plating.

Specifically, the surface of aluminum foil of the anode exposed on the first end surface of the resin molded body is etched with an acid containing nitric acid as a main component to remove an oxide film of the anode, and Zn plating is then performed. In the zincate treatment, preferably, both the first pickling and the second peeling are performed.

Subsequently, displacement plating by electroless Ag plating or electroless Cu plating is performed to form an Ag plating layer or a Cu plating layer.

The Ag plating layer is formed using a cyanide-containing electroless Ag plating bath as a preferred plating bath, which has a pH of preferably 8.0 or higher and 9.0 or lower (representative value: 8.5).

The Cu plating layer is formed using a neutral electroless Cu plating bath as a preferred plating bath, which has a pH of preferably 7.0 or higher and 8.5 or lower (representative value: 7.7).

The thicknesses of the Ag plating layer and the Cu plating layer can be controlled by controlling the conditions (e.g., concentrations of plating solutions, plating times) of the electroless Ag plating and the electroless Cu plating, respectively.

On a second end surface of the resin molded body is formed a second external electrode electrically connected to a cathode exposed on the second end surface. The cathode exposed on the second end surface is subjected to electroless Ag plating or electroless Cu plating.

The cathode (cathode lead-out layer) exposed on the second end surface may be or may not be subjected to a zincate treatment. When the cathode lead-out layer contains Al, the zincate treatment is preferably performed.

The cathode (cathode lead-out layer) exposed on the second end surface is subjected to electroless Ag plating or electroless Cu plating to form an Ag plating layer or a Cu plating layer.

The conditions of the zincate treatment and the plating baths can be the same as those in the case where the first end surface of the resin molded body is subjected to electroless Ag plating or electroless Cu plating.

Subsequently, a resin electrode layer is formed on each of the first end surface and the second end surface of the resin molded body.

The resin electrode layer may be formed by screen printing an electrode paste or by immersing the resin molded body in an electrode paste.

The electrode paste applied to the first end surface of the resin molded body is thermally cured to form the first external electrode.

Likewise, the electrode paste applied to the second end surface of the resin molded body is thermally cured to form the second external electrode.

The resin electrode layer is preferably formed by screen printing an electrode paste because the thus obtained resin electrode layer highly adheres to the resin molded body and has high thickness uniformity.

The electrode paste contains a conductive component and a resin component.

Preferably, the electrode paste contains a conductive component in an amount of 67 wt % to 97 wt % and a resin component in an amount of 3 wt % to 33 wt %.

More preferably, the electrode paste contains a conductive component in an amount of 72 wt % to 95 wt % and a resin component in an amount of 5 wt % to 28 wt %.

Still more preferably, the electrode paste contains a conductive component in an amount of 78 wt % to 95 wt % and a resin component in an amount of 5 wt % to 22 wt %.

Particularly preferably, the electrode paste contains a conductive component in an amount of 79 wt % to 89 wt % and a resin component in an amount of 11 wt % to 21 wt %.

The electrode paste may contain an organic solvent, and the organic solvent is preferably a glycol ether-based solvent. Examples include diethylene glycol monobutyl ether and diethylene glycol monophenyl ether.

The electrode paste may also contain an additive, if necessary. The amount of the additive added is preferably less than 5 wt % relative to the weight of the electrode paste.

Subsequently, preferably, outer plating layers are formed.

Preferably, the outer plating layers each include a Ni plating layer as the first outer plating layer and a Sn plating layer as the second outer plating layer.

The outer plating layers are formed on the resin electrode layers as the first external electrode and the second external electrode.

The electrolytic capacitor of the present invention can be obtained by the above steps.

The stack including the capacitor element preferably includes multiple capacitor elements but the stack may include only one capacitor element.

The method for manufacturing an electrolytic capacitor of the present invention performed using the above procedure forms only a single electroless Ag plating layer or only a single electroless Cu plating layer as an inner plating layer.

This method includes a smaller number of steps than the method including forming a Ni plating layer as an inner plating layer and then forming an Ag plating layer, achieving reduction in production cost.

### EXAMPLES

The following shows examples of the electrolytic capacitor of the present invention in which the ESR was evaluated. The present invention is not limited to these examples.

### Examples 1 to 10

A stack having a configuration shown in FIG. 1 and FIG. 2 was sealed in a sealing resin containing an epoxy resin and silica particles to obtain a resin molded body.

Thereafter, a zincate treatment was performed in which first and second end surfaces of the resin molded body were etched with an acid containing nitric acid as a main component, and a zinc film was formed.

Then, electroless Ag plating or electroless Cu plating was performed.

The film thickness of the electroless plating layer was varied as shown in Table 1 by varying the treatment time of the electroless Ag plating or the electroless Cu plating.

Thereafter, an Ag-containing electrode paste was applied to the end surfaces (the first end surface and the second end surface) of the resin molded body by screen printing, and was thermally cured at a drying temperature of 150° C. or higher and 200° C. or lower. Thus, resin electrode layers were formed. Further, a Ni plating layer and a Sn plating layer as outer plating layers were formed on a surface of each of the resin electrode layers to prepare an electrolytic capacitor.

The electrode paste had a formulation consisting of 50 wt % of Ag powder, 17 wt % of a phenolic resin, 6 wt % of an additive, 20 wt % of diethylene glycol monobutyl ether as a solvent, and 7 wt % of diethylene glycol monophenyl ether as a solvent.

### Comparative Examples 1 to 3

Electrolytic capacitors were produced as in Example 1 except that electroless Ni plating was performed instead of electroless Ag plating.

The thickness of the electroless plating layer was varied as shown in Table 1 by varying the treatment time of the electroless Ni plating.

### Comparative Example 4

An electrolytic capacitor was produced as in Example 1 except that electroless Ni plating was performed instead of electroless Ag plating, and electrolytic Ag plating was additionally performed. Thereby, two layers of a Ni plating layer and an Ag plating layer were formed as inner plating layers.

The sum of the treatment time of the electroless Ni plating and the treatment time of the electrolytic Ag plating is shown in Table 1.

The sum of the thicknesses of the two inner plating layers is shown in Table 1.

Measurement of Film Thickness and Electrical Properties

The thickness of each electrolytic capacitor was measured using SEM/EDS (JSM-7100F available from JEOL Ltd.) after cross sectional polishing of the LT plane of the electrolytic capacitor.

The ESR (mΩ) at 100 kHz was measured with an LCR meter (E4980A available from KEYSIGHT).

The results are shown in Table 1.

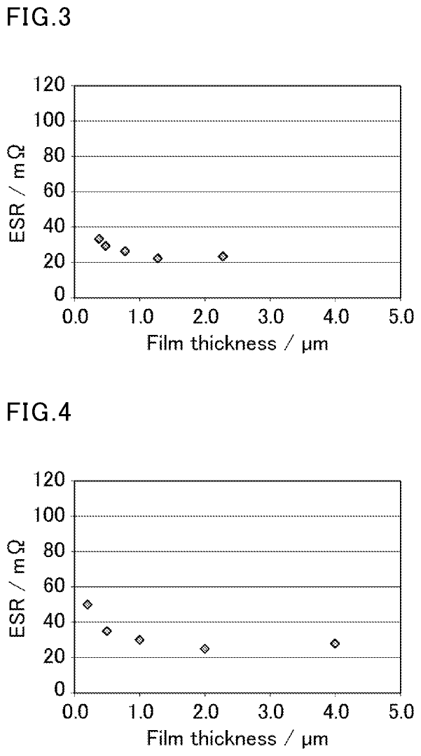

FIG. 3 is a graph showing the relation between the film thickness of the electroless Ag plating layer and the ESR in each of Examples 1 to 5.

FIG. 4 is a graph showing the relation between the film thickness of the electroless Cu plating layer and the ESR in each of Examples 6 to 10.

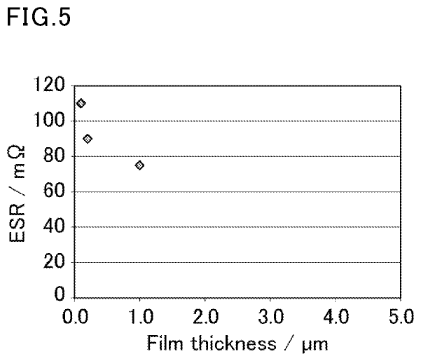

FIG. 5 is a graph showing the relation between the film thickness of the electroless Ni plating layer and the ESR in each of Comparative Examples 1 to 3.

TABLE 1

| | | Plating | Film | |
|---|---|---|---|---|
| | | time | thickness | ESR |
| | Inner plating | [min] | [μm] | [mΩ] |
| Example 1 | Zincate/Electroless Ag | 10 | 0.1 | 36 |
| Example 2 | Zincate/Electroless Ag | 20 | 0.2 | 32 |
| Example 3 | Zincate/Electroless Ag | 50 | 0.5 | 29 |
| Example 4 | Zincate/Electroless Ag | 90 | 1.0 | 25 |
| Example 5 | Zincate/Electroless Ag | 180 | 2.0 | 26 |
| Example 6 | Zincate/Electroless Cu | 2 | 0.2 | 50 |
| Example 7 | Zincate/Electroless Cu | 6 | 0.5 | 35 |
| Example 8 | Zincate/Electroless Cu | 10 | 1.0 | 30 |
| Example 9 | Zincate/Electroless Cu | 20 | 2.0 | 25 |
| Example 10 | Zincate/Electroless Cu | 40 | 4.0 | 28 |
| Comparative | Zincate/Electroless Ni | 0.5 | 0.1 | 110 |
| Example 1 | | | | |
| Comparative | Zincate/Electroless Ni | 1 | 0.2 | 90 |
| Example 2 | | | | |
| Comparative | Zincate/Electroless Ni | 5 | 1.0 | 75 |
| Example 3 | | | | |
| Comparative | Zincate/Electroless Ni + | 180 | 5.0 | 60 |
| Example 4 | Electrolytic Ag | | | |

Even the electrolytic capacitors of Examples 1 to 5 each including an electroless Ag plating layer having a relatively small thickness of 0.1 μm to 2.0 μm have a lower ESR than the electrolytic capacitors of Comparative Examples 1 to 4. The thickness of the electroless Ag plating layer is preferably 0.2 μm to 1.0 μm.

The electrolytic capacitors of Examples 6 to 10 each including an electroless Cu plating layer having a thickness of 0.2 μm to 4.0 μm have a lower ESR than the electrolytic capacitors of Comparative Examples 1 to 4. The thickness of the electroless Cu plating layer is preferably 0.5 μm to 2.0 μm.

The electrolytic capacitors of Comparative Examples 1 to 3 each including an electroless Ni plating layer have a higher ESR than the electrolytic capacitor of Comparative Example 4. This is presumably the influence of the oxide film on the surface of the electroless Ni plating layer.

### REFERENCE SIGNS LIST

1: electrolytic capacitor
3: anode
3a: valve-action metal foil
5: dielectric layer
7: cathode
7a: solid electrolyte layer
7b: conductive layer
7c: cathode lead-out layer
8: sealing resin
9: resin molded body
9a: first end surface of resin molded body
9b: second end surface of resin molded body
9c: bottom surface of resin molded body
9d: top surface of resin molded body
9e: first side surface of resin molded body
9f: second side surface of resin molded body
11: first external electrode
11a, 13a: Ag plating layer or Cu plating layer
11b, 13b: resin electrode layer
11c, 13c: outer plating layer
13: second external electrode
20: capacitor element
30: stack

1. An electrolytic capacitor comprising:
a cuboid resin molded body having a first end surface and a second end surface opposite to each other, the cuboid resin molded body including a stack that includes a capacitor element with an anode having a dielectric layer on a surface thereof and a cathode opposite to the anode, and a sealing resin that seals the stack, the anode being exposed on the first end surface and the cathode being exposed at the second end surface;
a first external electrode on the first end surface of the resin molded body and electrically connected to the anode exposed on the first end surface, the first external electrode including:
an Ag plating layer or a Cu plating layer on a surface of the anode exposed on the first end surface of the resin molded body; and
a resin electrode layer on a surface of the Ag plating layer or on a surface of the Cu plating layer and containing a conductive component and a resin component; and
a second external electrode on the second end surface of the resin molded body and electrically connected to the cathode exposed on the second end surface, the second external electrode including:
an Ag plating layer or a Cu plating layer on a surface of the cathode exposed on the second end surface of the resin molded body; and
a resin electrode layer on a surface of the Ag plating layer or on a surface of the Cu plating layer and containing a conductive component and a resin component.

2. The electrolytic capacitor according to claim 1, wherein the first external electrode and the second external electrode include the Ag plating layer, and the Ag plating layer has a thickness of 0.1 μm to 2.0 μm.

3. The electrolytic capacitor according to claim 1, wherein the first external electrode and the second external electrode include the Ag plating layer, and the Ag plating layer has a thickness of 0.2 μm to 1.0 μm.

4. The electrolytic capacitor according to claim 1, wherein the first external electrode and the second external electrode include the Cu plating layer, and the Cu plating layer has a thickness of 0.2 μm to 4.0 μm.

5. The electrolytic capacitor according to claim 1, wherein the first external electrode and the second external electrode include the Cu plating layer, and the Cu plating layer has a thickness of 0.5 μm to 2.0 μm.

6. The electrolytic capacitor according to claim 1, wherein the conductive component of the first external electrode and the second external electrode is Ag, Cu, Ni, or Sn; and the resin component of the first external electrode and the second external electrode an epoxy resin or a phenolic resin.

7. The electrolytic capacitor according to claim 1, wherein the conductive component of the first external electrode and the second external electrode is Ag.

8. The electrolytic capacitor according to claim 1, wherein the first external electrode and the second external electrode contain the conductive component in an amount of 67 wt % to 97 wt % and the resin component in an amount of 3 wt % to 33 wt %.

9. The electrolytic capacitor according to claim 1, wherein the first external electrode and the second external electrode each further comprise an outer plating layer on a surface of the resin electrode layer.

10. The electrolytic capacitor according to claim 9, wherein the outer plating layer includes at least one of a Ni plating layer or a Sn plating layer.

11. A method for manufacturing an electrolytic capacitor, the method comprising:
preparing a stack that includes a capacitor element with an anode having a dielectric layer on a surface thereof and a cathode opposite to the anode;
sealing the stack with a sealing resin to obtain a cuboid resin molded body;
forming a first external electrode on a first end surface of the resin molded body such that the first external electrode is electrically connected to the anode exposed on the first end surface, wherein the forming of the first external electrode includes electroless Ag plating or electroless Cu plating and forming a resin electrode layer on the first end surface of the resin molded body; and
forming a second external electrode on a second end surface of the resin molded body such that the second external electrode is electrically connected to the cathode exposed on the second end surface, wherein the forming of the second external electrode includes electroless Ag plating or electroless Cu plating and forming a resin electrode layer on the second end surface of the resin molded body.

12. The method for manufacturing an electrolytic capacitor according to claim 11, further comprising:
performing a zincate treatment of at least one of the first end surface of the resin molded body or the second end surface of the resin molded body prior to the electroless Ag plating or the electroless Cu plating when forming at least one of the first external electrode or the second external electrode.

13. The method for manufacturing an electrolytic capacitor according to claim 11, wherein the forming of the resin electrode layer of the first external electrode and the second external electrode comprises screen printing an electrode paste.

14. The method for manufacturing an electrolytic capacitor according to claim 11, wherein the forming of the resin electrode layer of the first external electrode and the second external electrode comprises immersing the resin molded body in an electrode paste.

15. The method for manufacturing an electrolytic capacitor according to claim 11, wherein the resin electrode layers of the first external electrode and the second external electrode include a conductive component and a resin component, the conductive component is Ag, Cu, Ni, or Sn, and the resin component is an epoxy resin or a phenolic resin.

16. The method for manufacturing an electrolytic capacitor according to claim 15, wherein the conductive component of the first external electrode and the second external electrode is Ag.

17. The method for manufacturing an electrolytic capacitor according to claim 13, wherein the electrode paste contains a conductive component in an amount of 60 wt % to 95 wt % and a resin component in an amount of 3 wt % to 30 wt %.

18. The method for manufacturing an electrolytic capacitor according to claim 14, wherein the electrode paste contains a conductive component in an amount of 60 wt % to 95 wt % and a resin component in an amount of 3 wt % to 30 wt %.

19. The method for manufacturing an electrolytic capacitor according to claim 11, wherein the forming of the first external electrode or the second external electrode further includes forming an outer plating layer on a surface of the resin electrode layer.

20. The method for manufacturing an electrolytic capacitor according to claim 19, wherein the outer plating layer includes at least one of a Ni plating layer or a Sn plating layer.
